(19) United States
(12) Patent Application Publication
(10) Pub. No.: US 2024/0007864 A1
(43) Pub. Date: Jan. 4, 2024

(54) COGNITIVE SENSING IN WIRELESS-WIRELINE PHYSICALLY CONVERGED ARCHITECTURES

(71) Applicant: PHYTunes, Inc., Palo Alto, CA (US)

(72) Inventors: Akula Aneesh REDDY, San Jose, CA (US); Jisung OH, Palo Alto, CA (US)

(73) Assignee: PHYTunes, Inc., Palo Alto, CA (US)

(21) Appl. No.: 17/853,094

(22) Filed: Jun. 29, 2022

(51) Int. Cl. H04W 16/14; H04B 3/32

(52) U.S. Cl. CPC H04W 16/14; H04B 3/32

(57) ABSTRACT

Embodiments of the present invention provide systems, devices and methods for identifying and selecting a preferred frequency spectrum for communication using a wireline media. In certain embodiments, a process of sensing traffic on the wireline media from other service is described and subsequent selection of a preferred frequency range in which interference from these other services is reduced.

### BACKGROUND

### A. Technical Field

The present invention relates generally to telecommunication systems, and more particularly, to wireless and wireline communication architectures that improve use of converged architectures with multiple wireline cables with different wireline cables for different locations/users. The enhancements enable higher throughputs for a given wireline infrastructure and support for wireline infrastructure with long cables.

### B. Background of the Invention

One skilled in the art will understand the importance of wireless communication systems (including LTE, 5G, 5GNR and Wi-Fi architectures) and the complexity of these systems as they are built out and maintained around the world. As the complexity of these systems increases and the resources available to them are allocated across an increasingly higher frequency spectrum, the management of wireless channels becomes more challenging. For example, a cellular base station must manage a large number of channels in communicating with UE (User Equipment) devices within its cell while the characteristics of these channels are constantly changing. This management of channels becomes more challenging in dense cities in which wireless signals must traverse a variety of physical barriers to reach a UE such as a cellphone. This channel quality and range issue is particularly problematic when channel frequencies increase and are more sensitive to interference, noise and varying channel properties.

Cellular subscriber lines (hereinafter, “CSL”) employ the novel concept of using the existing wireline infrastructure (e.g., telephone lines, fiber-optic cables, Ethernet wires, coaxial cables) in conjunction with the wireless infrastructure to extend the coverage of wireless signals quickly, inexpensively, and securely.

The architecture of the cloud-based cellular subscriber line intermediate frequency (hereinafter, “CSL-IF”) and cellular subscriber line radio frequency (hereinafter, “CSL-RF”) networks is illustrated in FIG. 1, which shows two low-cost units at the two ends of the wireline connection: the CSL-IF unit IF-modulates the wireless baseband signal and transmits the modulated signal to a CSL-RF unit at the other end of the wire. The CSL-RF unit up-converts the signal for wireless transmission to nearby client devices, such as IoT devices and smartphones. The CSL-IF unit is interfaced with a baseband unit (hereinafter, “BBU”) located at a cell-tower or at a central office of the CSP. The CSL-IF unit generates baseband digital streams from the BBU output (downlink) and converts the baseband digital streams to specific split signals for the BBU input (uplink).

The wireline connecting CSL-IF and CSL-RF units impacts CSL's performance. The wireline is used for transmitting IF-modulated baseband signals between the CSL-IF and CSL-RF units.

Accordingly, what is needed are systems, devices and methods that address the above-described issues.

### SUMMARY OF THE INVENTION

Embodiments disclosed herein are systems, devices, and methods for wireless-wireline physically converged architectures to reduce interference impacts related to existing wireline technologies using constituent wireline media. The techniques sense the wireline media to identify spectrum used by existing wireline technologies, and, in some embodiments, use measurements from the sensing to avoid certain identified spectrum in use. The disclosures allow coexistence of wireless-wireline physically converged architectures with existing wireline technologies that may use the same wireline media. The embodiments can be used to improve the performance of wireless communication systems that use wireline communication systems.

Certain embodiments described herein relate to a method of an intermediate transceiver and a distribution transceiver sharing a wireline medium with one or more other services, the method including: sensing the wireline medium to detect transmissions of the one or more other services; identifying, based on the sensing, a portion of spectrum of the wireline medium that (a) is not being used by the one or more other services, and (b) can support the intermediate transceiver and/or the distribution transceiver; and the intermediate transceiver and/or the distribution transceiver transmitting signals within one or more selected frequency bands within the identified portion of the spectrum of the wireline medium.

In certain embodiments, sensing the wireline medium includes performing cognitive sensing of the wireline medium. This sensing of the wireline medium is performed in order to detect the transmissions of the one or more other services on the wireline that may interfere with signals transmitted by the CSL-IF or CSL-RF devices. Some embodiments may also sense the wireline medium to detect the transmissions of the one or more other services by using the distribution transceiver to perform the sensing.

In certain embodiments, sensing the wireline medium to detect the transmissions of the one or more other services is performed by the intermediate transceiver in combination with the distribution transceiver. The sensing of the wireline medium to detect the transmissions of the one or more other services may be initiated by a management entity external to the intermediate transceiver and the distribution transceiver. The sensing of the wireline medium to detect the transmissions of the one or more other services may be performed during an initialization procedure. This sensing of the wireline medium to detect the transmissions of the one or more other services may be performed periodically or according to a schedule.

In some embodiments, sensing the wireline medium to detect the transmissions of the one or more other services is performed in response to determining interference on the wireline is sufficiently high. This sensing of the wireline medium to detect the transmissions of the one or more other services includes prioritizing sensing of a first candidate frequency band over sensing of a second candidate frequency band. In certain examples, prioritizing the sensing of the first candidate frequency band over the sensing of the second candidate frequency band includes at least one of: sensing the first candidate frequency band before sensing the second candidate frequency band; sensing the first candidate frequency band for a longer period of time than the second candidate frequency band; or sensing the first candidate frequency band with higher granularity than the second candidate frequency band.

In some embodiments, sensing the wireline medium to detect the transmissions of the one or more other services further includes selecting the first candidate frequency band based, at least in part, on at least one of: a position of the first candidate frequency band within the spectrum of the wireline medium relative to a position of the second candidate frequency band within the spectrum of the wireline medium; a position of a previously-used frequency band within the spectrum of the wireline medium, the previously-used frequency band having been used previously for transmission by the intermediate transceiver and/or the distribution transceiver; a position of a previously-identified frequency band within the spectrum of the wireline medium, the previously-identified frequency band having been identified during a prior sensing procedure as suitable for transmission and/or not being used by the one or more other services; or a position of a frequency band previously identified, via a sensing procedure conducted on a different wireline medium, as suitable for transmission and/or not in use.

In some embodiments, sensing the wireline medium to detect the transmissions of the one or more other services further includes identifying the first candidate frequency band based, at least in part, on at least one of: a previous sensing of the wireline medium; or a result of sensing another wireline medium connected to the intermediate transceiver. The previous sensing of the wireline medium may identify a frequency band suitable for transmission and/or not used by the one or more other services. In some examples, the result of sensing the another wireline medium connected to the intermediate transceiver may identify a frequency band that is not suitable for transmission and/or used by another service on the another wireline medium.

In some embodiments, sensing the wireline medium to detect the transmissions of the one or more other services may be performed in response to a trigger. The trigger may include one or more of: (i) a degradation of communication between the intermediate transceiver and the distribution transceiver, (ii) a pattern of degraded performance of one or both of the intermediate transceiver or the distribution transceiver, or (iii) an indication. In some examples, the indication may be from the distribution transceiver to the intermediate transceiver, from the intermediate transceiver to the distribution transceiver, from an external entity to the intermediate transceiver, or from the external entity to the distribution transceiver.

In some embodiments, the intermediate transceiver and/or the distribution transceiver transmitting signals within the one or more selected frequency bands within the identified portion of the spectrum of the wireline medium may include the intermediate transceiver and/or the distribution transceiver adapting a carrier frequency so as to position transmissions within the identified portion of the spectrum.

Certain techniques described herein relate to a system, including: an intermediate transceiver; and a distribution transceiver that may be coupled to the intermediate transceiver by a wireline medium, wherein at least one of the intermediate transceiver or the distribution transceiver may: sense the wireline medium to detect transmissions of one or more other services; identify, based on the sensing, a portion of spectrum of the wireline medium that (a) is not being used by the one or more other services, and (b) is suitable for use by the intermediate transceiver and/or the distribution transceiver; and transmit signals within one or more selected frequency bands within the identified portion of the spectrum of the wireline medium.

In some embodiments, the at least one of the intermediate transceiver or the distribution transceiver may sense the wireline medium to detect transmissions of the one or more other services at least in part by performing cognitive sensing of the wireline medium. The intermediate transceiver and the distribution transceiver may cooperate to sense the wireline medium to detect transmissions of the one or more other services. In certain examples, at least one of the intermediate transceiver or the distribution transceiver may sense the wireline medium to detect transmissions of the one or more other services in response to an instruction from a management entity external to the intermediate transceiver and the distribution transceiver.

In some embodiments, the intermediate transceiver and the distribution transceiver may sense the wireline medium to detect transmissions of the one or more other services during an initialization procedure. In some examples, the at least one of the intermediate transceiver or the distribution transceiver may sense the wireline medium to detect transmissions of the one or more other services periodically or according to a schedule. At least one of the intermediate transceiver or the distribution transceiver may sense the wireline medium to detect transmissions of the one or more other services in response to a determination that the distribution transceiver is not providing service to any connected device downstream of the distribution transceiver.

In some embodiments, at least one of the intermediate transceiver or the distribution transceiver may sense the wireline medium to detect transmissions of the one or more other services at least in part by prioritizing sensing of a first candidate frequency band over sensing of a second candidate frequency band. Prioritizing the sensing of the first candidate frequency band over the sensing of the second candidate frequency band may include at least one of: sensing the first candidate frequency band before sensing the second candidate frequency band; sensing the first candidate frequency band for a longer period of time than the second candidate frequency band; or sensing the first candidate frequency band with higher granularity than the second candidate frequency band.

In some embodiments, at least one of the intermediate transceiver or the distribution transceiver may further sense the wireline medium to detect the transmissions of the one or more other services based, at least in part, on at least one of: a position of the first candidate frequency band within the spectrum of the wireline medium relative to a position of the second candidate frequency band within the spectrum of the wireline medium; a position of a previously-used frequency band within the spectrum of the wireline medium, the previously-used frequency band having been used previously for transmission by the intermediate transceiver and/or the distribution transceiver; a position of a previously-identified frequency band within the spectrum of the wireline medium, the previously-identified frequency band having been identified during a prior sensing procedure as suitable for transmission and/or not being used by the one or more other services; or a position of a frequency band previously identified, via a sensing procedure conducted on a different wireline medium, as suitable for transmission and/or not in use. The at least one of the intermediate transceiver or the distribution transceiver may further sense the wireline medium to detect the transmissions of the one or more other services based, at least in part, on at least one of: a previous sensing of the wireline medium; or a result of sensing another wireline medium connected to the intermediate transceiver. The previous sensing of the wireline medium may identify a frequency band suitable for transmission and/or not used by the one or more other services. The result of sensing the another wireline medium coupled to the intermediate transceiver may identify a frequency band suitable for transmission and/or used by another service on the another wireline medium.

In some embodiments, at least one of the intermediate transceiver or the distribution transceiver may further detect a trigger, wherein the sensing of the wireline medium to detect the transmissions of the one or more other services is in response to the trigger. The trigger may include one or more of: (i) a degradation to communication between the intermediate transceiver and the distribution transceiver, (ii) a pattern of degraded performance of one or both of the intermediate transceiver or the distribution transceiver, or (iii) an indication. The intermediate transceiver may receive the indication from the distribution transceiver or from an external entity. The distribution transceiver may receive the indication from the intermediate transceiver or from an external entity.

In certain embodiments, at least one of the intermediate transceiver or the distribution transceiver may transmit the signals within the one or more selected frequency bands within the identified portion of the spectrum of the wireline medium at least in part by adapting a carrier frequency so as to position transmissions within the identified portion of the spectrum.

The intermediate transceiver may include a CSL-IF unit and the distribution transceiver may include a CSL-RF unit.

In some embodiments, the distribution transceiver is a first distribution transceiver, and the wireline medium is a first wireline medium, and the one or more other services are a first set of one or more other services, and the one or more frequency bands are first one or more frequency bands, and the system may further include: a second distribution transceiver may be coupled to the intermediate transceiver by a second wireline medium, wherein at least one of the intermediate transceiver or the second distribution transceiver may: sense the second wireline medium to detect transmissions of a second set of one or more other services; identify, based on the sensing, a portion of spectrum of the second wireline medium that (a) is not being used by the second set of one or more other services, and (b) is suitable for use by the intermediate transceiver and/or the second distribution transceiver; and transmit signals within second one or more frequency bands within the identified portion of the spectrum of the second wireline medium.

In some embodiments, at least one of the intermediate transceiver or the second distribution transceiver may sense the second wireline medium to detect transmissions of the second one or more other services at least in part by performing cognitive sensing of the second wireline medium. The intermediate transceiver and the second distribution transceiver may cooperate to sense the second wireline medium to detect transmissions of the second one or more other services. In certain examples, the intermediate transceiver may (i) cooperate with the first distribution transceiver to sense the first wireline medium during a first time period, and (ii) may cooperate with the second distribution transceiver to sense the second wireline medium during a second time period.

In some embodiments, the intermediate transceiver may be coupled to a plurality of distribution transceivers, including the first distribution transceiver and the second distribution transceiver, via a respective plurality of wireline media, including the first wireline medium and the second wireline medium, and wherein the intermediate transceiver may cycle through the plurality of distribution transceivers to sense each of the respective wireline media to detect transmissions of respective sets of one or more other services.

In some embodiments, the intermediate transceiver may be coupled to a plurality of distribution transceivers, including the first distribution transceiver and the second distribution transceiver, via a respective plurality of wireline media, including the first wireline medium and the second wireline medium, and wherein the intermediate transceiver is configured to sense each of the respective wireline media to detect transmissions of respective sets of one or more other services periodically or according to a schedule.

In some embodiments, the intermediate transceiver includes a CSL-IF unit, the first distribution transceiver includes a first CSL-RF unit, and the second distribution transceiver includes a second CSL-RF unit.

Embodiments of the invention may also employ cloud-based management and target more recent wider-frequency-band and multiple-input-multiple-output LTE and Wi-Fi transmission systems.

Certain features and advantages of the present invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a CSL cloud-based architecture that includes CSL-IF and CSL-RF units connected to each other by a cable (e.g., twisted pair, coaxial cable, etc.).

FIG. 2 illustrates that higher frequencies experience more attenuation in cables, longer cables introduce more attenuation than shorter cables, and attenuation properties are impacted by the type of cable (e.g., CAT5e, coaxial, etc.).

FIG. 3 illustrates exemplary spectrum overlap between different technologies communicated on a wireline medium.

FIG. 4 is an example illustration of spectral usage sensed by an example CSL system and CSL spectrum placement in response to sensing results according to various embodiments of the invention.

FIG. 5 is a block diagram of a CSL-IF unit according to various embodiments of the invention.

FIG. 6 is a block diagram of a CSL-RF unit according to various embodiments of the invention.

### DETAILED DESCRIPTION OF THE PREFERRED EMBODIMENTS

Embodiments of the present invention provide systems, devices and methods for addressing interference and scheduling resource blocks within a wireless and wireline architecture across various channels within the system. In certain examples, the architecture leverages pre-existing copper within a building to allow a signal to traverse physical barriers, such as walls, on copper wire while using wireless portions of the channel to communicate signals in air both outside and inside the building. Exemplary wireless and wireline architectures are described in U.S. Patent Publication No. 2021/0099277 A1; and J. M. Cioffi et al., “Wireless-wireline physically converged architectures,” WIPO Patent Publication No. WO2021/062311, all of the above-referenced publications are hereby incorporated by reference in their entireties. CSL uses the existing wireline infrastructure (e.g., telephone lines, fiber-optic cables, Ethernet wires, coaxial cables, etc.) in conjunction with the wireless infrastructure to extend the coverage of wireless signals quickly, inexpensively, and securely. CSL can include hardware and/or software components to transmit and/or process signals at a variety of frequencies, including radio frequencies (RF), baseband frequencies, and/or intermediate frequencies (IF).

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different electrical components, circuits, devices and systems. The embodiments of the present invention may function in various different types of environments wherein channel sensitivity and range are adversely affected by physical barriers within the signal path. Furthermore, connections between components within the figures are not intended to be limited to direct connections. Rather, connections between these components may be modified, re-formatted or otherwise changed by intermediary components.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

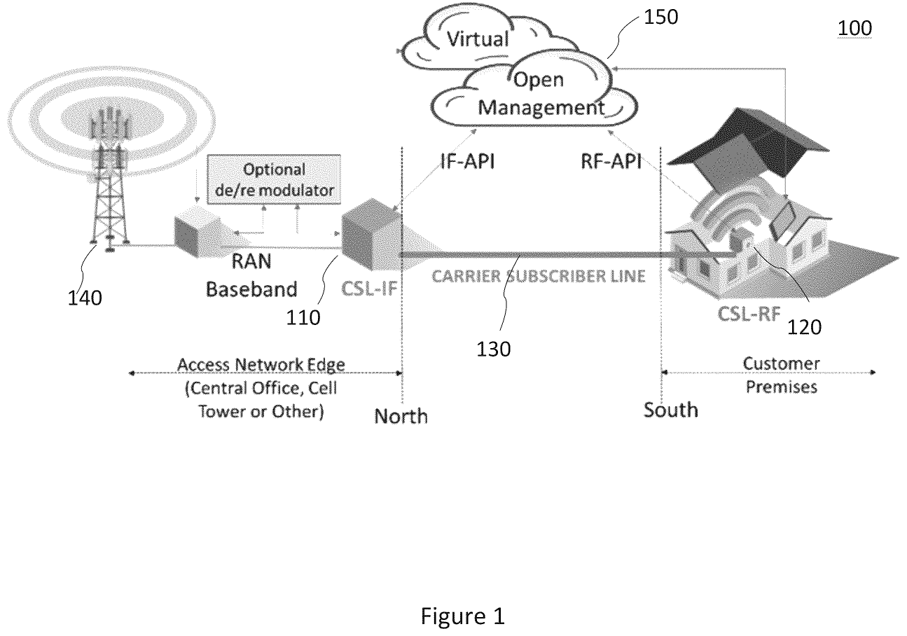

FIG. 1 illustrates a CSL cloud-based architecture 100 that includes CSL-IF 110 and CSL-RF units 120 connected to each other by a cable 130 (e.g., twisted pair, coaxial cable, etc.). The CSL-IF unit 110, which can be considered to be an intermediate transceiver, interfaces with a broadband unit (BBU) 140 (or, more generally, a base station) located, for example, at a cell-tower or at a central office of the cellular service provider (CSP). The CSL-IF unit 110 generates baseband digital streams from the BBU output (downlink direction) and converts the baseband digital streams to specific O-RAN split signals for the BBU input (uplink direction).

In the downlink direction (toward user equipment), the CSL-IF unit 110 receives baseband samples from the cellular radio access network (RAN), IF-modulates the wireless baseband signal, and transmits the IF-modulated signal over the cable 130 to a CSL-RF unit 120 at the other end of the cable 130. The CSL-RF unit 120, which can be considered to be a distribution transceiver, then up-converts the signal to RF and transmits RF signals to user equipment (UE) (e.g., IoT devices, smartphones, etc.) within its range. Similarly, in the uplink direction (toward the BBU), the CSL-RF unit 120 receives RF signals from the UEs, down-converts them to the IF, and transmits IF-modulated signals over the cable to the CSL-IF unit 110. The CSL-IF unit 110 then converts the IF-modulated signals to O-RAN signals and transmits them to the BBU 140.

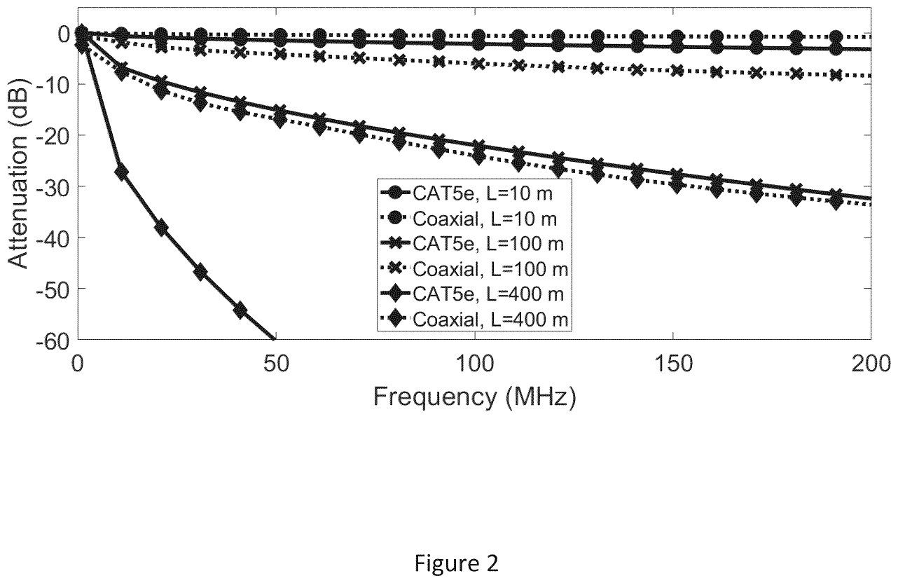

The wireline medium 130 (also referred to herein as a cable) that connects the CSL-IF 110 and CSL-RF units 120 allows the CSL-IF unit 110 to send IF-modulated baseband signals to the CSL-RF unit 120, and it also allows the CSL-RF unit 120 to send to the CSL-IF unit 110 the uplink samples received from the UEs after down-converting them from the radio-frequency range to the intermediate frequency range. The cable 130 has an impact on the performance of the CSL system. For example, wireline communication (over the cable) is significantly impacted by cable attenuation, which is a function of cable length and frequency. FIG. 2 is a plot comparing the attenuations of 10-meter, 100-meter, and 400-meter CAT5e and coaxial cables. FIG. 2 illustrates that (1) higher frequencies experience more attenuation in cables, (2) longer cables introduce more attenuation than shorter cables, and (3) trends (1) and (2) are impacted by the type of cable (e.g., CAT5e, coaxial, etc.).

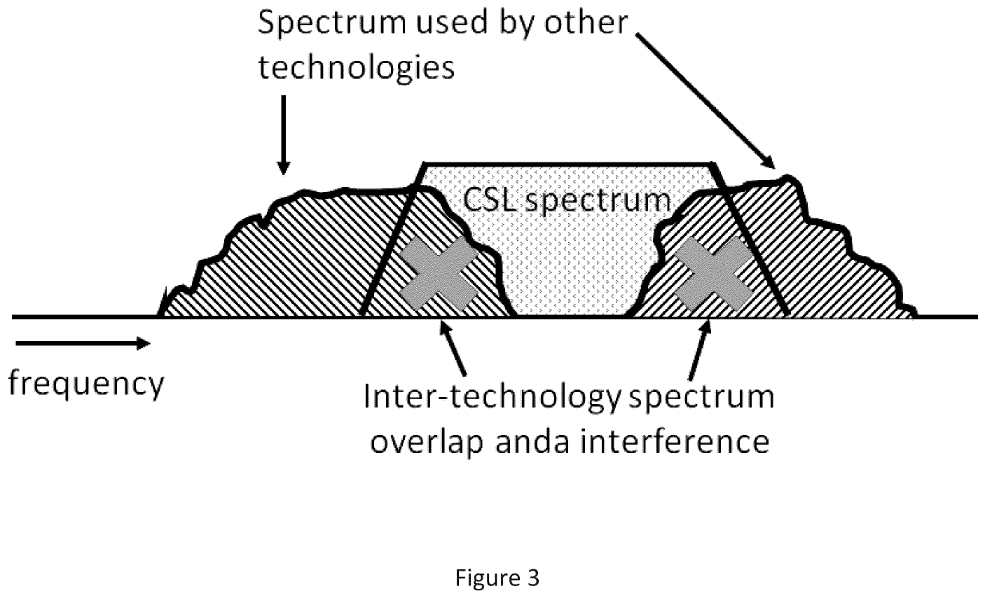

Referring again to FIG. 1, the cable 130 may be available to or in use by some other type or types of system(s) or technologies (e.g., digital subscriber line (DSL) systems or DOCSIS (for cable modems), etc.), and limited bandwidth may be available for transmission of CSL signals. If the CSL-IF unit or CSL-RF unit transmits in a portion of the wireline spectrum that overlaps the spectrum used by other technologies (e.g., DSL, DOCSIS, etc.), the transmissions may interfere, as illustrated in FIG. 3. In such cases, in order to avoid/reduce interference between CSL and the other technology (or technologies), transmissions of the CSL-IF and CSL-RF units should, generally speaking (e.g., absent use of techniques that allow spectral overlap, such as spread spectrum), avoid transmitting within the spectrum used by other technologies sharing the wireline medium.

Although information about spectrum usage by other technologies on a particular cable could potentially be collected using manual measurements by a technician or by collecting such information from other sources (e.g., information shared by operators/providers of the other technologies), such a manual approach may be inefficient in many cases or difficult to scale up as the number of CSL deployments increases, and such information may not be readily available in some cases. Accordingly, it would be a significant improvement to provide an automated, easy-to-manage, scalable approach that would allow CSL (and similar systems) to coexist with existing wireline technologies in wireless-wireline physically converged architectures. Such an approach and associated systems, devices, and methods are described herein.

In some embodiments, cognitive sensing (e.g., using sensing or channel measurements to automatically identify available spectrum and/or spectrum in use; and/or finding spectrum “holes” by sensing the spectrum in an unsupervised manner) of the wireline medium is used, and the IF signal's carrier frequency is adapted based on the results of the cognitive sensing. The sensing of the wireline medium may be performed by the CSL-IF unit 110 and/or the CSL-RF unit 120 at any of a variety of times to find “holes” (e.g., unused or available frequency bands) in the spectrum of the wireline medium. For example, the CSL-IF unit 110 and/or CSL-RF unit 120 can perform sensing (a) when they are initialized, (b) according to a schedule (e.g., periodically), which may help them to detect intermittently-present transmissions of other wireline technologies, (c) when the CSL-RF unit is detected to service no UEs, and/or (d) based on triggers, such as (i) the detection of poor CSL performance, (ii) patterns in time instances of periods of poor CSL performance (e.g., CSL connection drops every 5 ms), or (iii) based on an indication. In embodiments in which a CSL-IF unit 110 is connected to multiple CSL-RF units 120, the respective wireline media can be sensed independently (e.g., the CSL-IF unit can cycle through all of the media/CSL-RF units in accordance with any of the ways described above). For example, the CSL-IF unit 110 can (i) cooperate with a first distribution transceiver of a plurality of distribution transceivers to sense a first wireline medium during a first time period, and (ii) cooperate with a second distribution transceiver to sense a second wireline medium during a second time period. Alternatively or in addition, the intermediate transceiver can cooperate with multiple distribution transceivers to sense their respective wireline media during the same time period. For example, the intermediate transceiver may be able to perform sensing (either by itself or in cooperation with one or more distribution transceivers) on two or more wireline media at the same time or during overlapping time periods.

The sensing can be performed in a variety of ways to determine the strength of transmissions in parts of the wireline spectrum that are useful for CSL-IF/CSL-RF communications. It may be performed using techniques like cognitive RF sensing (e.g., adaptive, spectrum-sensing RF technology that can reconfigure itself, without user intervention, to operate in a variety of frequency bands with a variety of waveform modulation under various operating and environmental conditions). The sensing may be performed with the goal of finding lower frequencies (which have lower attenuation; refer again to FIG. 2) suitable for CSL (or other) transmissions. For example, for CSL, the sensing can start at lower frequencies and proceed upward, ending once a sufficient quantity of spectrum without significant interference from other technologies has been detected (e.g., by the CSL-IF and CSL-RF units).

For CSL units that are already in operation, the sensing may be performed with higher preference given to one or more lower frequencies (which generally attenuate signals less than higher frequencies); frequencies close to those that are currently in use by the CSL units; frequencies close to or within a portion of the spectrum of the wireline medium that was identified as being suitable during a previous sensing; frequencies close to or within a portion of the spectrum of the wireline medium that was identified as not being used by the one or more other services during a previous sensing; frequencies close to or within a portion of the spectrum of the wireline medium that was identified, via sensing another wireline medium connected to the intermediate transceiver, as being suitable; frequencies close to or within a portion of the spectrum of the wireline medium that was identified, via sensing of another wireline medium connected to the intermediate transceiver, as not being used by another service on the another wireline medium. Giving a subset of frequencies higher preference may be accomplished, for example, by sensing the subset of frequencies earlier in the sensing process (e.g., first), for a longer period of time than other frequencies, and/or with higher granularity than other frequency bands (e.g., by sensing more densely in frequency). Alternatively or in addition, the sensing may be performed for longer duration to detect intermittently-present transmissions from other wireline technologies.

The sensing may avoid any spectrum already known to be occupied, or likely to be occupied, by other wireline technologies. For example, if it is known that a particular cable has an installed system, and the frequencies used by the installed system are known, the frequencies used by the installed system can be ignored or skipped by the sensing. Such knowledge can be configured in (e.g., using CSL management devices) or communicated to (e.g., by a management entity) one or both of the pair of CSL units or obtained from collocated devices (e.g., from a digital subscriber line access multiplexer (DSLAM), a headend, etc.).

The frequency granularity of sensing measurements can be selected in any suitable manner, such as based on the bandwidth of baseband signals to be transmitted. For example, low-frequency-resolution sensing may be sufficient if the baseband bandwidth is relatively high (e.g., 100 MHz), whereas higher-frequency-resolution sensing can be used if the baseband bandwidth is lower (e.g., 100 kHz).

Based on the sensing results, a pair of CSL units (e.g., a CSL-IF unit and a CSL-RF unit connected to the CSL-IF unit) or a management system 150 can estimate the spectrum being used by other technologies on the wireline media and position the transmissions of the CSL-IF and CSL-RF units in a portion (or portions) of the spectrum free of transmissions of other systems. To place the CSL transmissions, the IF frequency or the value of the carrier frequency used for IF-modulated signals used by the pair of CSL units can be determined so that it avoids spectrum used by any other technologies using the wireline medium used by the pair of CSL units.

The determination of the placement of the CSL transmissions can also consider the baseband bandwidth of the CSL signals to be transmitted across the wireline medium (e.g., because the amount of spectrum used, when the signals are centered at the IF frequencies, is proportional to the bandwidth).

It is to be appreciated that although it is assumed herein that the CSL-IF 110 and CSL-RF units 120 transmit IF-modulated signals, this is not a requirement. Specifically, if the CSL-IF and CSL-RF units (or non-CSL units performing similar functions) transmit baseband signals, those signals can also be generated such that they avoid spectrum in use by other technologies. For example, if an existing system on a cable uses frequencies between 10 kHz and 100 kHz, and the bandwidth of transmissions between the CSL-IF and CSL-RF units is MHz, those transmissions could be baseband transmissions (e.g., transmitted by a multicarrier system that allocates no bits or power to subcarriers up to 100 kHz). Likewise, if an existing system places transmissions in a frequency band from 20-25 MHz and the bandwidth of the CSL-IF and CSL-RF unit transmissions is 15 MHz, the CSL-IF and CSL-RF units can place their signals below the 20-25 MHz band in use by the existing system.

The attenuation characteristics of the cable may also be considered in the determination of where to place the CSL signals. In some cases, the lower frequencies may be preferable for the CSL signals because they attenuate signals less than higher frequencies do (generally speaking). For example, available spectrum around 20 MHz may be preferred to a similar amount of available spectrum at 40 MHz due to the lower attenuation at 20 MHz as compared to 40 MHz.

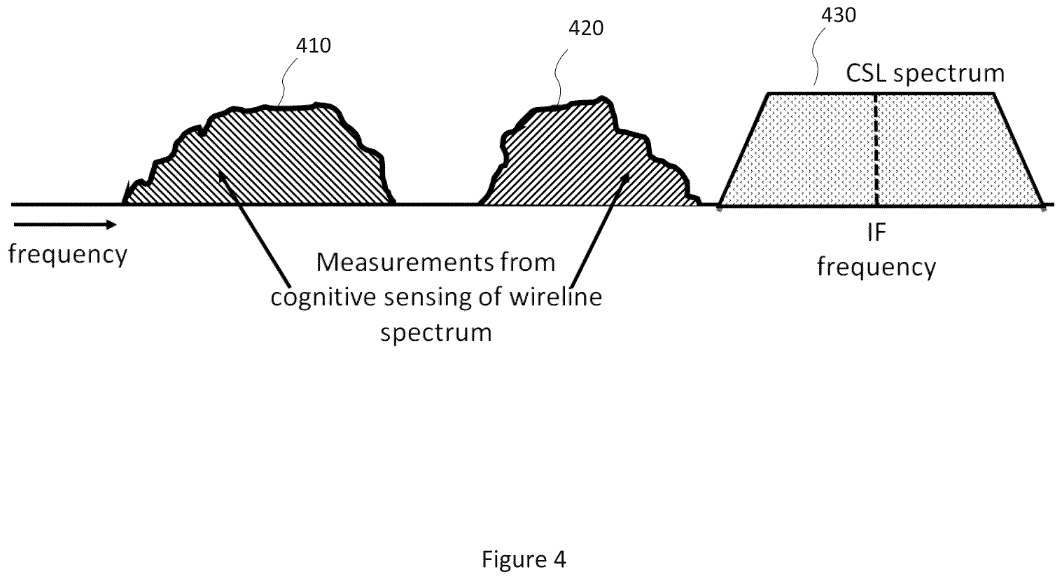

FIG. 4 is an example illustration of spectral usage sensed by an example CSL system and CSL spectrum placement in response to the sensing results. In the illustrated example, spectral usage by an installed system is detected in two portions of the bandwidth 410 420, and the CSL spectrum 430 is adapted based on the sensing results to avoid the portions of spectrum 410, 420 that are sensed to be in use by other wireline technologies using the cable. In the illustrated example, the spectrum of CSL signals is placed above the two portions of spectrum in use by the other wireline technologies.

It is to be appreciated that the CSL-IF and CSL-RF (or equivalent) units may use time-division duplexing (TDD), in which case uplink and downlink transmission can take place within the same bandwidth but at different times, or frequency-division duplexing (FDD), in which case uplink and downlink transmission can take place simultaneously but in nonoverlapping bands. In the case of TDD, the sensing may identify a single portion of spectrum suitable for transmission in both directions. In the case of FDD, the sensing may identify suitable separate upstream and downstream spectrum.

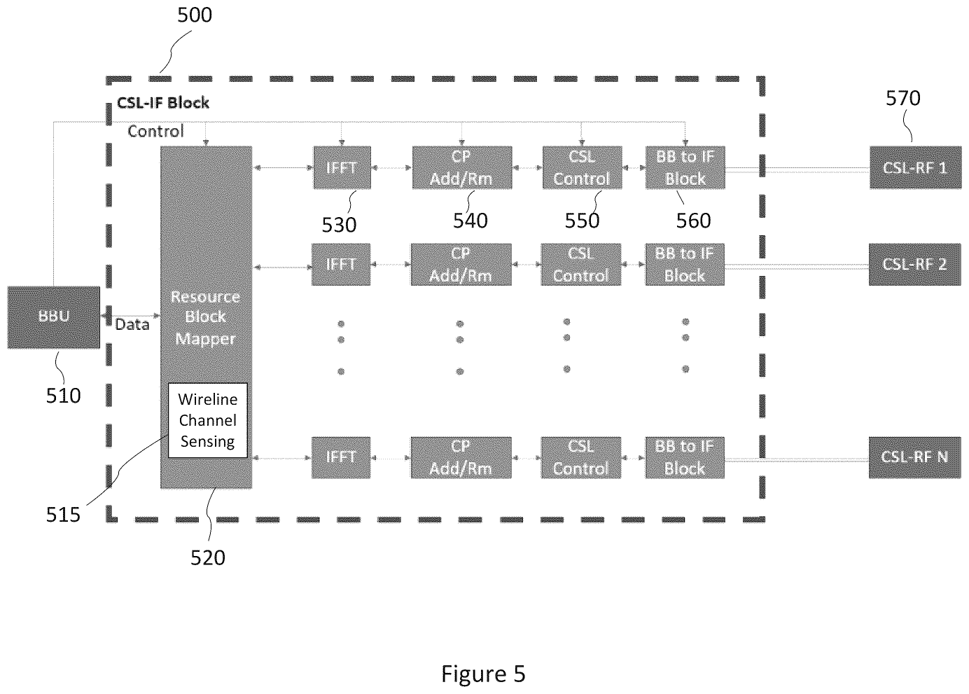

FIG. 5 illustrates an exemplary CSL-IF block according to various embodiments of the invention. As shown the CSL-IF block 500 is coupled to a baseband unit 510 and receives downlink data/control information and transmits uplink data/control information. A resource block mapper 520 is coupled within the CSL-IF block 500 and manages resource block frequency transmission on wireline connectivity to one or more CSL-RF 570 blocks. In certain embodiments, the resource block mapper 520 divides available frequency spectrum into sub-blocks that allows the resource block mapper to provide a frequency shift across at least one of the sub-blocks prior to transmission on the wireline. The frequency shift allows the system to influence a scheduler within a wireless device, such as a cellular base station or Wi-Fi access point, to schedule resource blocks within a particular sub-block(s) to one or more CSL-RF devices. This frequency shift allows for improved bandwidth management within a wireline portion because the channel estimation information received by the scheduler will be influenced by the frequency shift on the wireline portion of the system between the CSL-IF block 500 and one or more CSL-RF blocks 570.

In certain embodiments, the resource block mapper 520 comprises a wireline channel sensing element 515 that senses traffic on relevant channels on the wireline. In certain embodiments, the wireline channel sensing element 515 senses traffic on certain wireless channel independent of any frequency sub-block partitions or frequency shifting performed on signals to be communicated on a wireline. In other embodiments, the wireline channel sensing element 515 works in conjunction with frequency shifting functionality such that relevant wireless channels are identified in relation to the frequency shifting. In either embodiment, the wireline channel sensing element 515 is able to identify preferred channels on the wireline connection(s) that are free of or have minimal traffic from other service providers.

One or more transmission paths are defined within the CSL-IF block 500. As shown, exemplary transmission paths comprise an Inverse Fast Fourier Transform (IFFT) block 530 that converts a received signal from a frequency domain vector signal to a time domain vector signal. A control plane add/remove block 540 adds control information into a downlink signal that enables a CSL-RF device 570 to properly process the signal. In certain embodiments, the control plane add/remove block 540 may also remove certain control information from the downlink signal. A CSL control block 550 analyzes certain control information within the signal. This information may include parameters related to signal interference. A baseband-to-intermediate frequency block 560 converts the baseband signal to an intermediate frequency such that the signals transmitted on the wireline are adapted in accordance with the sensed wireline traffic and/or identified frequency shift across the sub-block(s) that are to be implemented.

In other embodiments, the control information is also communicated on discrete control connections from the resource block mapper 520 to one or more of the other blocks 530, 540, 550 and 560 within the CSL-IF block 500.

The CSL-IF block 500 provides an uplink signal path that receives an uplink signal from the CSL-RF block 570 and that comprises a baseband-to-intermediate frequency block 565 that converts the received uplink signal from the wireline to a baseband signal. A CSL control block 555 analyzes certain control information within the signal including parameters related to interference. A control plane add/remove block 545 may analyze control plane information related to the uplink signal including parameters related to signal interference. A Fast Fourier Transform (FFT) block 535 that converts the uplink signal from a time domain vector signal to a frequency domain vector signal.

In other embodiments, the control information may be communicated on discrete control connections from the resource block mapper 520 to one or more of the other blocks 535, 545, 555 and 565 within the CSL-IF block 500.

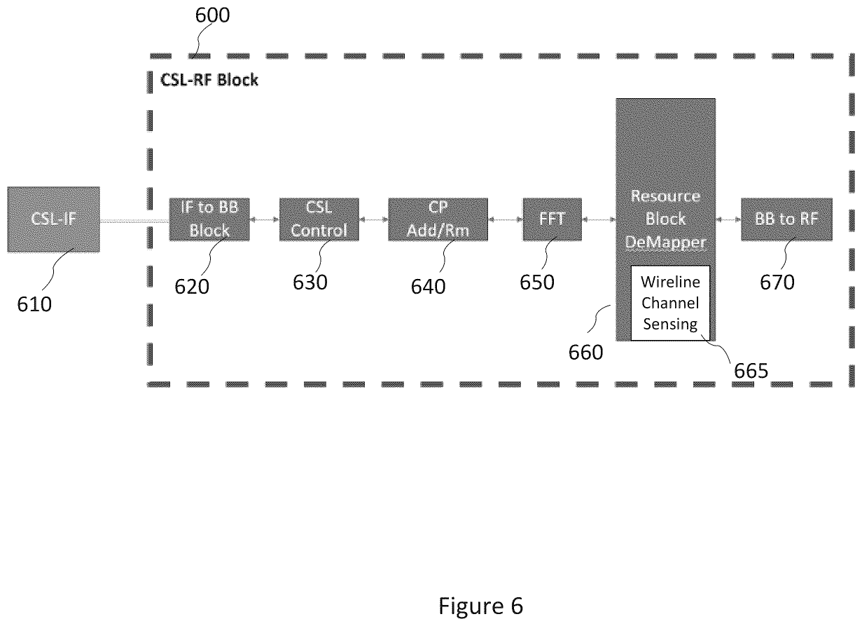

FIG. 6 illustrates an exemplary CL-RF block according to various embodiments of the invention. As shown, the CSL-RF block 600 is coupled to transmit and receive data/control information within a CSL-IF block 610. This CSL-RF block 600 is able to reverse frequency shifting performed on downlink signals and perform frequency shifting on uplink signals.

Referencing a downlink signal, an intermediate frequency to baseband block 620 converts the received downlink signal to a corresponding baseband signal. A CSL control block 630 analyzes control information embedded within the signal. In certain embodiments, this CSL control block 630 identifies frequency shift information corresponding to the signal and communicates this information to a subsequent block(s). This frequency shift information may be embedded within the signal (as shown) or may be communicated by discrete control lines (not shown). A control plane remove block 640 removes at least a portion of the control information that had been inserted by the CSL-IF device 610. A Fast Fourier Transform (FFT) block 650 converts the signal from a time domain vector signal to a frequency domain vector signal.

A resource block demapper 660 receives the frequency shift information and performs a reverse frequency shift relative to the shift performed by the CSL-IF 610. For example, if a sub-block frequency is shifted higher by the CSL-IF 610, then the resource block demapper 660 performs a lower frequency shift equal in magnitude to the frequency shift performed by the CSL-IF 610. In certain embodiments, a wireline channel sensing element 665 is coupled within the resource block demapper 660. This wireline channel sensing element 665 senses traffic across a variety of channels on the wireline connection to identify if other service traffic is being communicated and to determine which frequencies are being used by this other service provider(s). This sensed wireline traffic may be processed internally within the CSL-RF block 600 or communicated to the CSL-IF block 610 for subsequent analysis. A baseband to radio frequency block 670 generates a radio frequency that is subsequently transmitted to wireless devices within the cell or Wi-Fi network.

In other embodiments, the control information may be communicated on discrete control connections from the resource block demapper 660 to one or more of the other blocks 620, 630, 640, 650 and 670 within the CSL-RF block 600.

For an uplink signal, a wireless signal is received from a UE and converted from an RF signal to a baseband signal using a radio frequency-to-baseband block 675. The resource block demapper 660 maps the uplink signal resource blocks into corresponding blocks for transmission onto the wireline portion of the system. As previously discussed, this mapping and demapping may be based, at least partially, on wireline channel sensing 665 to identify wireline channels that are not actively transmitting other signals. An inverse Fast Fourier Transform (IFFT) block 655 converts the uplink signal from a frequency domain vector signal to a time domain vector signal. A control plane add block 645 inserts control information into the uplink signal including information about resource block mapping. A CSL control block 635 identifies frequency shift information corresponding to the signal and communicates this information to a subsequent block(s). A baseband-to-intermediate frequency block 625 converts the uplink signal from a baseband signal to an intermediate frequency signal in preparation for transmission on the wireline channel. Thereafter, the uplink signal is transmitted on the wireline to the CSL-IF device 610.

In other embodiments, the control information may be communicated on discrete control connections from the resource block demapper 660 to one or more of the other blocks 625, 635, 645, 655 and 675 within the CSL-RF block 600.

One skilled in the art will recognize that sensing traffic on the wireline connection(s) allows for a more informed scheduling of resource blocks within the system. Furthermore, this sensed traffic information may be used in conjunction with frequency shifts in an attempt to further define a sub-block of frequencies that are presented to a scheduler with preferred channel quality characteristics.

It is to be understood that although the disclosures herein are largely in the context of CSL and a wireless-wireline converged architecture, the disclosures are not limited to the described environments or applications. It will be appreciated by those having ordinary skill in the art that operations such as up-conversion and down-conversion may take place as desired to position the bandwidth of a signal in a desired location of the spectrum for transmission to/from the intermediate transceiver (e.g., CSL-IF unit) and/or for transmission to/from the distribution transceiver(s) (e.g., CSL-RF unit(s)). Furthermore, although certain 3GPP/cellular terminology and acronyms or initialisms are used herein (e.g., RB, BBU, RAN, UE, etc.), those having ordinary skill in the art will understand that other terms may be used in other contexts (e.g., Wi-Fi, IEEE 802.11 standards, etc.).

In the foregoing description and in the accompanying drawings, specific terminology has been set forth to provide a thorough understanding of the disclosed embodiments. In some instances, the terminology or drawings may imply specific details that are not required to practice the invention. To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used herein, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

To the extent that the terms “include(s),” “having,” “has,” “with,” and variants thereof are used herein, such terms are intended to be inclusive in a manner similar to the term “comprising,” i.e., meaning “including but not limited to.”

The terms “exemplary” and “embodiment” are used to express examples, not preferences or requirements. The term “coupled” is used herein to express a direct connection/attachment as well as a connection/attachment through one or more intervening elements or structures. The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The foregoing description of the invention has been described for purposes of clarity and understanding. It is not intended to limit the invention to the precise form disclosed. Various modifications may be possible within the scope and equivalence of the appended claims.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

What is claimed is:

1. A method of an intermediate transceiver and a distribution transceiver sharing a wireline medium with one or more other services, the method comprising:
sensing the wireline medium to detect transmissions of the one or more other services;
identifying, based on the sensing, a portion of spectrum of the wireline medium that (a) is not being used by the one or more other services, and (b) is suitable for use by the intermediate transceiver and/or the distribution transceiver; and
the intermediate transceiver and/or the distribution transceiver transmitting signals within one or more selected frequency bands within the identified portion of the spectrum of the wireline medium.

2. The method of claim 1, wherein sensing the wireline medium comprises performing cognitive sensing of the wireline medium.

3. The method of claim 1, wherein sensing the wireline medium to detect the transmissions of the one or more other services is performed by the intermediate transceiver.

4. The method of claim 1, wherein sensing the wireline medium to detect the transmissions of the one or more other services is performed by the distribution transceiver.

5. The method of claim 1, wherein sensing the wireline medium to detect the transmissions of the one or more other services is performed by the intermediate transceiver in combination with the distribution transceiver.

6. The method of claim 1, wherein sensing the wireline medium to detect the transmissions of the one or more other services is initiated by a management entity external to the intermediate transceiver and the distribution transceiver.

7. The method of claim 1, wherein sensing the wireline medium to detect the transmissions of the one or more other services is performed during an initialization procedure.

8. The method of claim 1, wherein sensing the wireline medium to detect the transmissions of the one or more other services is performed periodically or according to a schedule.

9. The method of claim 1, wherein sensing the wireline medium to detect the transmissions of the one or more other services is performed in response to determining that the distribution transceiver is not providing service to any connected device downstream of the distribution transceiver.

10. The method of claim 1, wherein sensing the wireline medium to detect the transmissions of the one or more other services is performed in response to a trigger.

11. The method of claim 10, wherein the trigger comprises one or more of: (i) a degradation to communication between the intermediate transceiver and the distribution transceiver, (ii) a pattern of degraded performance of one or both of the intermediate transceiver or the distribution transceiver, or (iii) an indication.

12. A system, comprising:
an intermediate transceiver; and
a distribution transceiver configured to be coupled to the intermediate transceiver by a wireline medium,
wherein at least one of the intermediate transceiver or the distribution transceiver is configured to:
sense the wireline medium to detect transmissions of one or more other services;
identify, based on the sensing, a portion of spectrum of the wireline medium that (a) is not being used by the one or more other services, and (b) is suitable for use by the intermediate transceiver and/or the distribution transceiver; and
transmit signals within one or more selected frequency bands within the identified portion of the spectrum of the wireline medium.

13. The system of claim 12, wherein the at least one of the intermediate transceiver or the distribution transceiver is configured to sense the wireline medium to detect transmissions of the one or more other services at least in part by performing cognitive sensing of the wireline medium.

14. The system of claim 12, wherein the intermediate transceiver and the distribution transceiver are configured to cooperate to sense the wireline medium to detect transmissions of the one or more other services.

15. The system of claim 12, wherein the at least one of the intermediate transceiver or the distribution transceiver is configured to sense the wireline medium to detect transmissions of the one or more other services in response to an instruction from a management entity external to the intermediate transceiver and the distribution transceiver.

16. The system of claim 12, wherein the intermediate transceiver and the distribution transceiver are configured to sense the wireline medium to detect transmissions of the one or more other services during an initialization procedure.

17. The system of claim 12, wherein the at least one of the intermediate transceiver or the distribution transceiver is configured to sense the wireline medium to detect transmissions of the one or more other services periodically or according to a schedule.

18. The system of claim 12, wherein the at least one of the intermediate transceiver or the distribution transceiver is configured to sense the wireline medium to detect transmissions of the one or more other services in response to a determination that the distribution transceiver is not providing service to any connected device downstream of the distribution transceiver.

19. The system of claim 12, wherein the at least one of the intermediate transceiver or the distribution transceiver is configured to sense the wireline medium to detect transmissions of the one or more other services at least in part by prioritizing sensing of a first candidate frequency band over sensing of a second candidate frequency band.

20. The system of claim 19, wherein prioritizing the sensing of the first candidate frequency band over the sensing of the second candidate frequency band comprises at least one of:
sensing the first candidate frequency band before sensing the second candidate frequency band;
sensing the first candidate frequency band for a longer period of time than the second candidate frequency band; or
sensing the first candidate frequency band with higher granularity than the second candidate frequency band.
